(19) United States
(12) Patent Application Publication
(10) Pub. No.: US 2016/0097414 A1
(43) Pub. Date: Apr. 7, 2016

(54) Nested Polygonal Member Locking Device

(71) Applicant: Zeljko Sabo, Garland, TX (US)

(72) Inventor: Zeljko Sabo, Garland, TX (US)

(21) Appl. No.: 14/507,946

(22) Filed: Oct. 7, 2014

(51) Int. Cl. F16B 7/14

(52) U.S. Cl. CPC F16B 7/1427

(57) ABSTRACT

A nested polygonal member locking device secures nested square tubing together into a static position relative to each other. The device includes an outer perimeter shape of an inner member being polygonal defining a plurality of corners and a groove extending into one of the corners. A peripheral shape of an outer member being polygonal defining a plurality of outside corners and a slot extending through the outer member into one of the outer corners. The slot is alignable with the groove. A collar defines a circular channel receiving the outer member. A flange extends inwardly from an interior face of the collar into channel. The flange is positionable in the slot and the groove simultaneously by rotation of the collar whereby the flange inhibits disengagement of the inner member from the outer member.

### BACKGROUND OF THE DISCLOSURE

### Field of the Disclosure

The disclosure relates to locking devices and more particularly pertains to a new locking device for securing nested square tubing together into a static position relative to each other.

### SUMMARY OF THE DISCLOSURE

An embodiment of the disclosure meets the needs presented above by generally comprising an outer perimeter shape of an inner member being polygonal defining a plurality of corners and a groove extending into one of the corners. A peripheral shape of an outer member being polygonal defining a plurality of outside corners and a slot extending through the outer member into one of the outer corners. The slot is alignable with the groove. A collar defines a circular channel receiving the outer member. A flange extends inwardly from an interior face of the collar into channel. The flange is positionable in the slot and the groove simultaneously by rotation of the collar whereby the flange inhibits disengagement of the inner member from the outer member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a nested polygonal member locking device according to an embodiment of the disclosure.

FIG. 2 is a cross-sectional view of an embodiment of the disclosure taken along line 2-2 of FIG. 1.

FIG. 3 is a cross-sectional view of an embodiment of the disclosure taken along line 3-3 of FIG. 1.

FIG. 4 is a bottom view of an embodiment of the disclosure.

FIG. 5 is an exploded partial view of an embodiment of the disclosure.

### DESCRIPTION OF THE PREFERRED EMBODIMENT

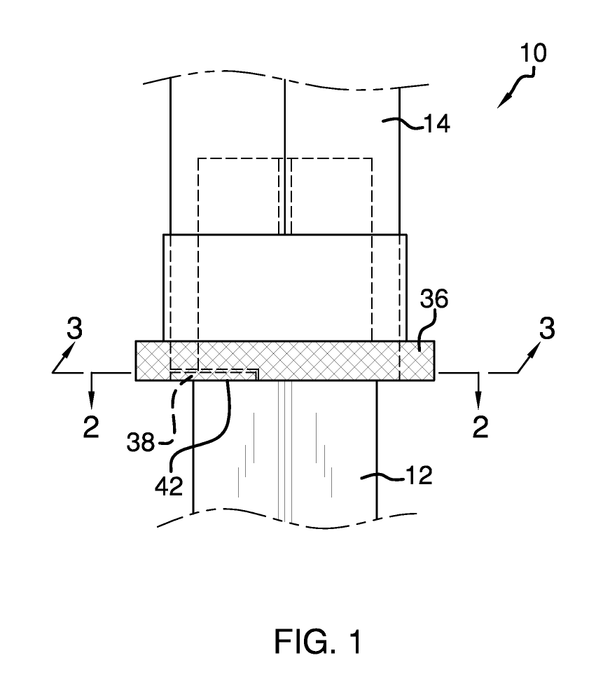

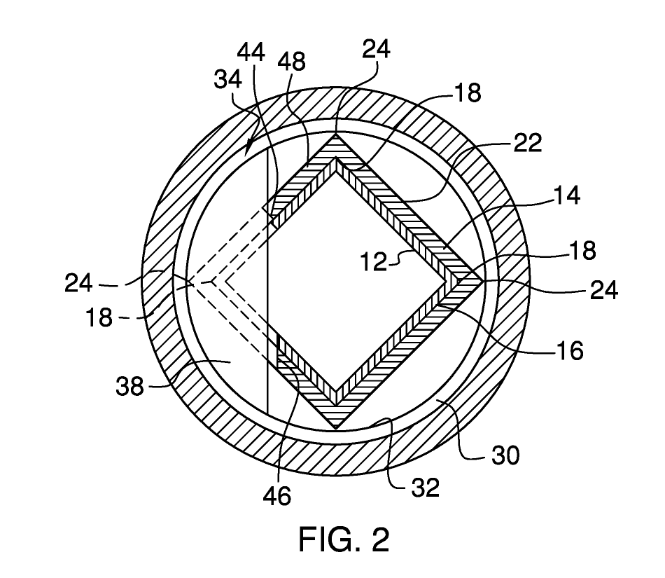

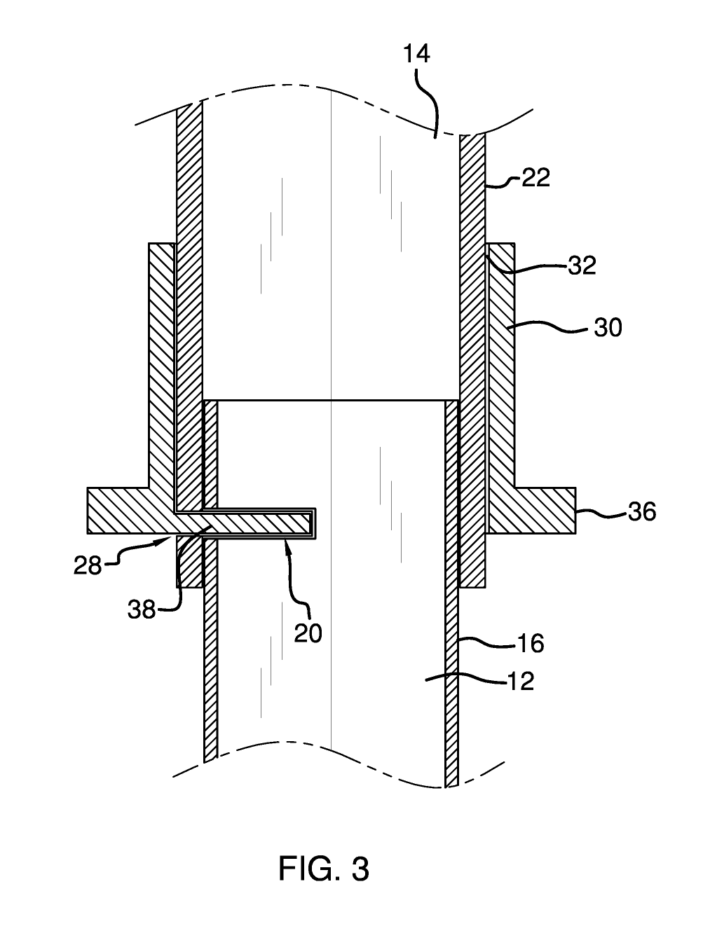

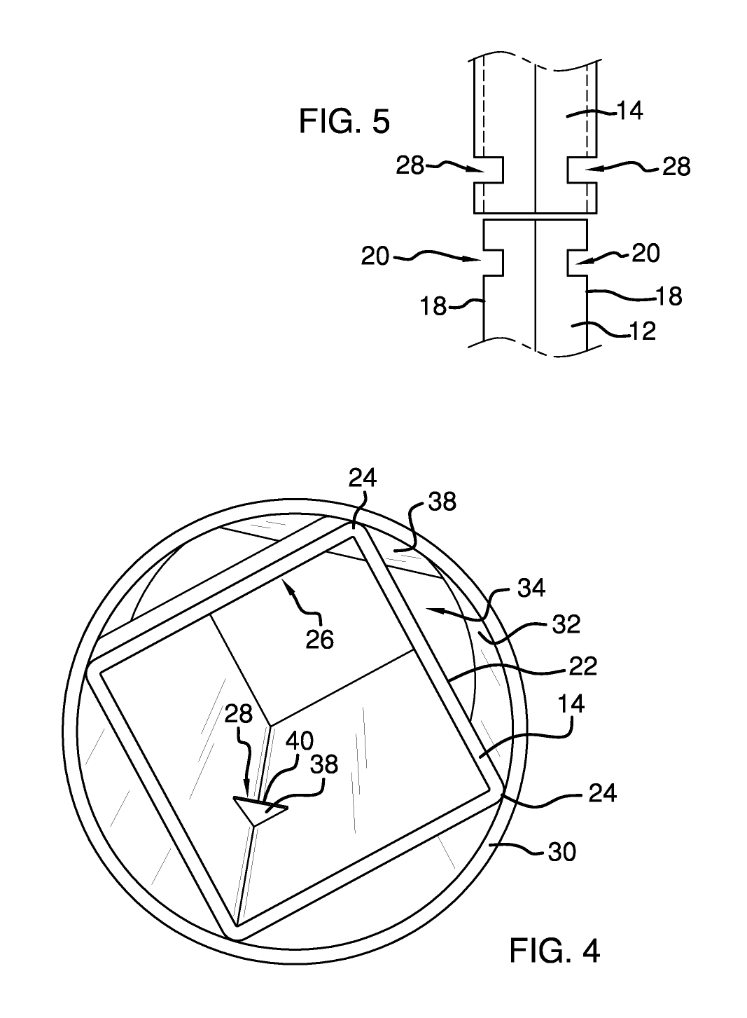

With reference now to the drawings, and in particular to FIGS. 1 through 5 thereof, a new locking device embodying the principles and concepts of an embodiment of the disclosure and generally designated by the reference numeral 10 will be described.

As best illustrated in FIGS. 1 through 5, the nested polygonal member locking device 10 generally comprises an inner member 12 and an outer member 14. An outer perimeter shape 16 of the inner member 12 is polygonal defining a plurality of corners 18. The inner member 12 may be an elongated square tube. The inner member 12 is structured to have a groove 20 extending into one of the corners 18 transverse relative to a longitudinal axis of the inner member 12. A peripheral shape 22 of the outer member 14 is polygonal defining a plurality of outside corners 24. An interior shape 26 of the outer member 14 is polygonal and complementary to the outer perimeter shape 16 of the inner member 12 wherein the inner member 12 is insertable into the outer member 14. The outer member 14 is structured to have a slot 28 extending through the outer member 14. The slot 28 extends into one of the outer corners 24. The slot 28 is alignable with the groove 20. Each of the outer member 14 and the inner member 12 may be square tubes.

A collar 30 has an annular interior face 32 defining a circular channel 34. The outer member 14 is insertable into the channel 34 allowing rotation of the collar 30 relative to the outer member 14. The collar 30 has a knurled outer surface 36 facilitating grasping and rotation of the collar 30 relative to the outer member 14. A flange 38 is coupled to the collar 30. The flange 38 extends inwardly from the interior face 32 into channel 34. The flange 38 is alignable with the slot 28 and the groove 20. The collar 30 is rotatable such that the flange 38 is positionable in the slot 28 and the groove 20. Thus, the flange 38 inhibits disengagement of the inner member 12 from the outer member 14 by obstructing sliding of the inner member 12 within the outer member 14. A distal edge 40 of the flange 38 relative to the interior face 32 of the collar 30 is straight. The flange 38 may be coplanar with a bottom end 42 of the collar 30.

The slot 28 has a first end 44 and a second end 46. The first end 44 is positioned in a side 48 of the outer member 14. The first end 44 is straight and transverse to the side 48 of the outer member 14 such that the second end 44 of the slot 28 will stop rotation of the collar 30 as the flange 38 abuts the first end 44 of the slot 28. The second end 46 of the slot 28 is oblique relative to the side 48 of the outer member 14 allowing the flange 38 to enter the slot 28 as the collar 30 is rotated moving the flange 38 into the slot 28.

Spacing between the inner member 12 and the outer member 14 when the inner member is inserted into the outer member 14 may be between 0.5 to 2.5 millimeters to achieve a stable connection between the outer member 14 and inner member 12.

In use, the device 10 may be employed in a variety of assemblies as the device 10 provides for quick solid connection of nested tubes or bars. Thus, the device 10 may be incorporated into any situation in which nested tubes are extended and locked into place. Further, a tube acting as the outer member 14 may be seated on a projection (which may serve as the inner member 12) to provide a quick connector for installation of structures such as racks, frames, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A nested polygonal member locking device comprising:
an inner member, an outer perimeter shape of said inner member being polygonal defining a plurality of corners, said inner member having a groove extending into one of said corners;
an outer member, a peripheral shape of said outer member being polygonal defining a plurality of outside corners, an interior shape of said outer member being polygonal and complementary to said outer perimeter shape of said inner member wherein said inner member is insertable into said outer member, said outer member having a slot extending through said outer member, said slot extending into one of said outer corners, said slot being alignable with said groove;
a collar having an annular interior face defining a circular channel, said outer member being insertable into said channel; and
a flange coupled to said collar, said flange extending inwardly from said interior face into channel perpendicular to a central axis extending between opposite open ends of said channel, said flange being alignable with said slot and said groove, said collar being rotatable in a plane perpendicular to said inner and outer members such that said flange is positioned in said slot and said groove whereby said flange inhibits disengagement of said inner member from said outer member.

2. The device of claim 1, further comprising each of said outer member and said inner member being square tubes.

3. The device of claim 1, further comprising a distal edge of said flange relative to said interior face of said collar being straight.

4. The device of claim 1, further comprising said slot having a first end and a second end, said first end being positioned in a side of said outer polygonal member, said first end being straight and transverse to said side of said outer polygonal member.

5. The device of claim 4, further comprising said second end of said slot being oblique relative to said side of said outer polygonal member.

6. The device of claim 1, further comprising said flange being coplanar with a bottom end of said collar.

7. The device of claim 1, further comprising said collar having a knurled outer surface.

8. A nested polygonal member locking device comprising:
an inner member, an outer perimeter shape of said inner member being polygonal defining a plurality of corners, said inner member being structured to have a groove extending into one of said corners;
an outer member, a peripheral shape of said outer member being polygonal defining a plurality of outside corners, an interior shape of said outer member being polygonal and complementary to said outer perimeter shape of said inner member wherein said inner member is insertable into said outer member, said outer member being structured to have a slot extending through said outer member, said slot extending into one of said outer corners, said slot being alignable with said groove, each of said outer member and said inner member being square tubes;
a collar having an annular interior face defining a circular channel, said outer member being insertable into said channel, said collar having a knurled outer surface;
a flange coupled to said collar, said flange extending inwardly from said interior face into channel perpendicular to a central axis extending between opposite open ends of said channel, said flange being alignable with said slot and said groove, said collar being rotatable in a plane perpendicular to said inner and outer members such that said flange is positioned in said slot and said groove whereby said flange inhibits disengagement of said inner member from said outer member, a distal edge of said flange relative to said interior face of said collar being straight, said flange being coplanar with a bottom end of said collar; and
said slot having a first end and a second end, said first end being positioned in a side of said outer polygonal member, said first end being straight and transverse to said side of said outer polygonal member, said second end of said slot being oblique relative to said side of said outer polygonal member.
